(19) United States
(12) Patent Application Publication
(10) Pub. No.: US 2026/0207977 A1
(43) Pub. Date: Jul. 23, 2026

(54) PORTABLE OXYGEN CYLINDER

(71) Applicant: Guirong Tan, Zhanjiang City (CN)

(72) Inventor: Guirong Tan, Zhanjiang City (CN)

(21) Appl. No.: 19/030,874

(22) Filed: Jan. 17, 2025

(51) Int. Cl. A62B 7/02; A62B 9/02; A62B 9/06

(52) U.S. Cl. CPC A62B 7/02; A62B 9/022; A62B 9/06

(57) ABSTRACT

Disclosed is a portable oxygen cylinder, including an oxygen cylinder body, an upper surface of the oxygen cylinder body is provided with a through hole, a valve is fixedly mounted on the through hole, a valve stem is mounted inside the valve, a pressing head is slidably snap-fitted with a top end of the valve stem, and a sealing ring is arranged on an inner side wall of the valve. The portable oxygen cylinder is simplified into two main components: the oxygen cylinder body and the oxygen mask. The oxygen mask can be snap-fitted with a top of the portable oxygen cylinder for combined connection, featuring rich functions, easy to carry, and not easy to lose. When oxygen inhalation is needed, the oxygen mask is snap-fitted with the pressing head, and the pressing head is then slid to complete the oxygen inhalation operation.

### TECHNICAL FIELD

The present disclosure belongs to the technical field of oxygen cylinders, and specifically relates to a portable oxygen cylinder.

### BACKGROUND

A portable oxygen cylinder is a device used to supply oxygen to a human body, and is widely applied in various fields such as daily life and healthcare. Since oxygen inhalation can also help people in a plateau alleviate altitude sickness, a compact portable oxygen cylinder is highly favored and extensively used in people's daily lives.

Existing oxygen cylinders usually have many components, making them difficult to carry, and the components are prone to loss and contamination. Moreover, they are hard to operate, with single functions and poor use experience, which is not conducive to relieving hypoxic conditions, and fails to give good effects on alleviating physical discomfort.

To this end, the present disclosure provides a portable oxygen cylinder.

### SUMMARY

The present disclosure aims to overcome the shortcomings in the prior art and solve at least one technical problem in the background.

The technical solution adopted by the present disclosure is as follows: a portable oxygen cylinder, including an oxygen cylinder body, an upper surface of the oxygen cylinder body is provided with a through hole, a valve is fixedly mounted on the through hole, a valve stem is mounted on and connected to a surface of the valve, a pressing head is slidably snap-fitted with a top end of the valve stem, a first sealing ring is arranged on an inner side wall of the valve, the first sealing ring is tightly against an inner wall of the valve, the valve stem is provided with a second sealing ring, the second sealing ring is mounted inside the valve, and an oxygen mask is slidably snap-fitted with one side of the pressing head.

A flow groove is formed inside the pressing head, a bottom end of the flow groove is slidably snap-fitted with the valve stem, the pressing head is adaptable to other types of oxygen masks.

A recessed portion is formed on a surface of the pressing head, and an anti-slide groove is formed on a surface of the recessed portion.

The oxygen mask includes a connecting portion that is slidably snap-fitted with the pressing head, a connecting hole is formed on a surface of the connecting portion, the connecting hole is adapted to the pressing head, a mask portion is fixedly mounted on one side of the connecting portion, and a ventilation hole is formed on a surface of the mask portion.

One side of the mask portion is set as an opening, upper and lower surfaces of the opening are both provided with arc-shaped grooves, and the arc-shaped grooves are fitted to a user’s face.

A snap-fitted steel ring is fixedly arranged on an upper surface of the oxygen cylinder body, a snap-fitted block is formed on an inner side wall of the mask portion, and the snap-fitted block is adapted to the snap-fitted steel ring.

A rebound device is arranged inside the valve, the valve stem is mounted on one end of the rebound device, and a valve chamber is mounted on the other end of the rebound device.

The present disclosure has the following beneficial effects:

The present disclosure provides a portable oxygen cylinder with a simple structure, convenient use, and comprehensive functions. The portable oxygen cylinder is simplified into two main components: an oxygen cylinder body and an oxygen mask. The oxygen mask can be snap-fitted with a top of the portable oxygen cylinder for combined connection, featuring rich functions, easy to carry, and not easy to lose. When oxygen inhalation is needed, the oxygen mask is snap-fitted with the pressing head, the pressing head is then slid to complete the oxygen inhalation operation, simplifying the oxygen inhalation operation steps, being helpful to the relaxation of the mood in a hypoxia state of and alleviating physical discomfort.

### BRIEF DESCRIPTION OF THE DRAWINGS

The present disclosure will be further described below with reference to the accompanying drawings.

FIG. 1 is a structural schematic diagram according to an embodiment of the present disclosure from a first perspective.

FIG. 2 is a structural schematic diagram of a cross section according to an embodiment of the present disclosure.

FIG. 3 is a structural schematic diagram according to an embodiment of the present disclosure from a second perspective.

FIG. 4 is a structural schematic diagram of a pressing head and an oxygen mask according to an embodiment of the present disclosure.

FIG. 5 is a structural schematic diagram that an oxygen cylinder body is combined with an oxygen mask according to an embodiment of the present disclosure.

FIG. 6 is a structural schematic diagram of an oxygen mask and a pressing head according to an embodiment of the present disclosure.

FIG. 7 is a structural schematic diagram of a valve according to an embodiment of the present disclosure.

Reference numerals in the accompanying drawings: 1. oxygen cylinder body; 2. pressing head; 3. oxygen mask; 301. connecting portion; 302. mask portion; 303. ventilation hole; 304. arc-shaped groove; 4. flow groove; 5. valve; 6. anti-slide groove; 7. snap-fitted steel ring; 8. rebound device; 9. valve stem; 10. first sealing ring; 11. valve chamber; and 12. second sealing ring

### DETAILED DESCRIPTIONS OF THE EMBODIMENTS

In order to make the technical means, inventive features, objectives and effects of the present disclosure clear and understandable, the present disclosure is further described in combination with the specific embodiments below.

### Embodiment 1:

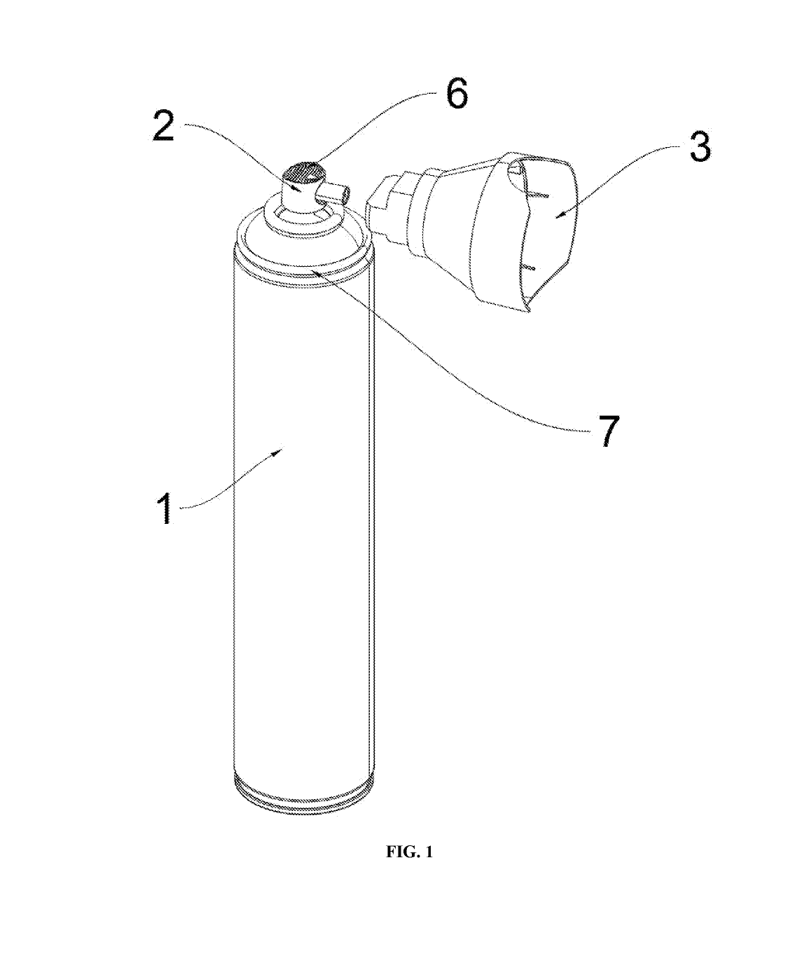

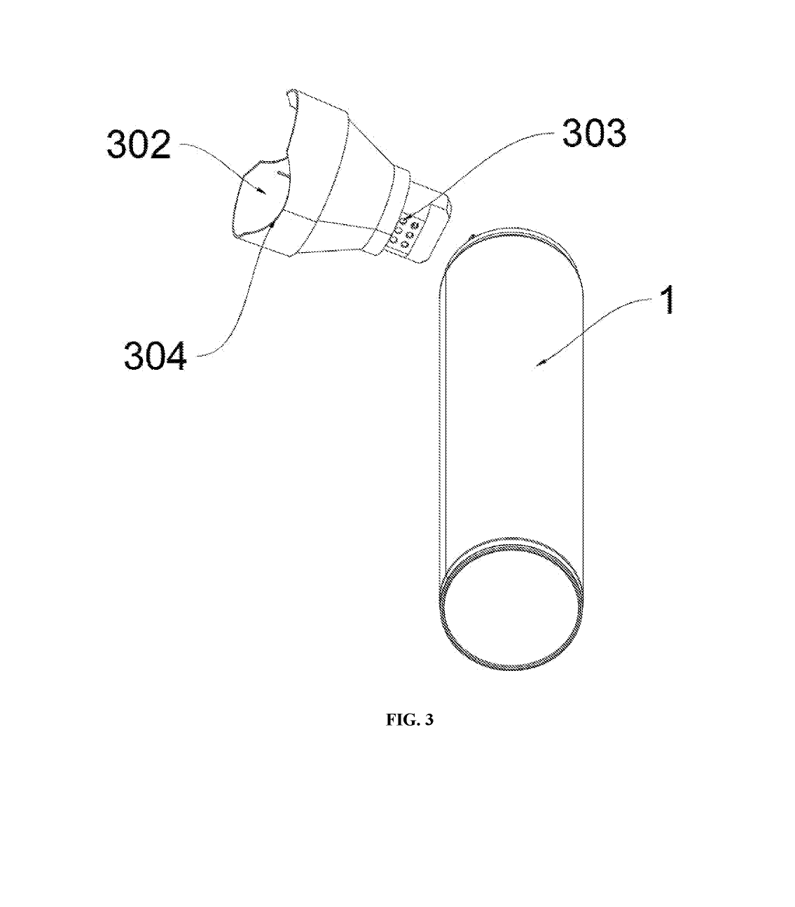

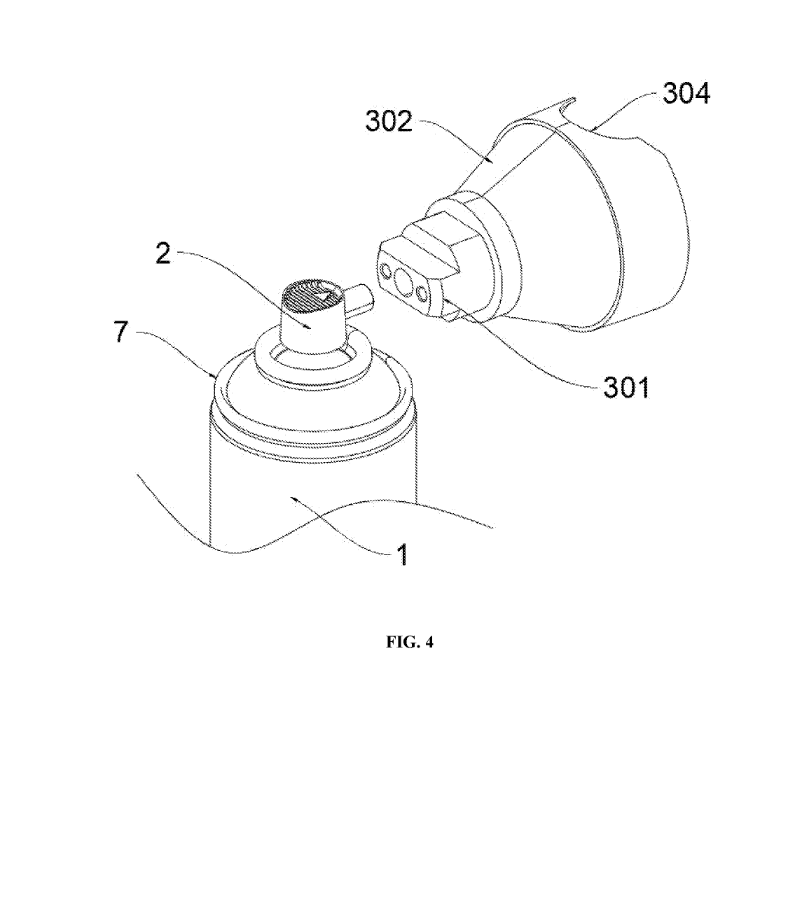

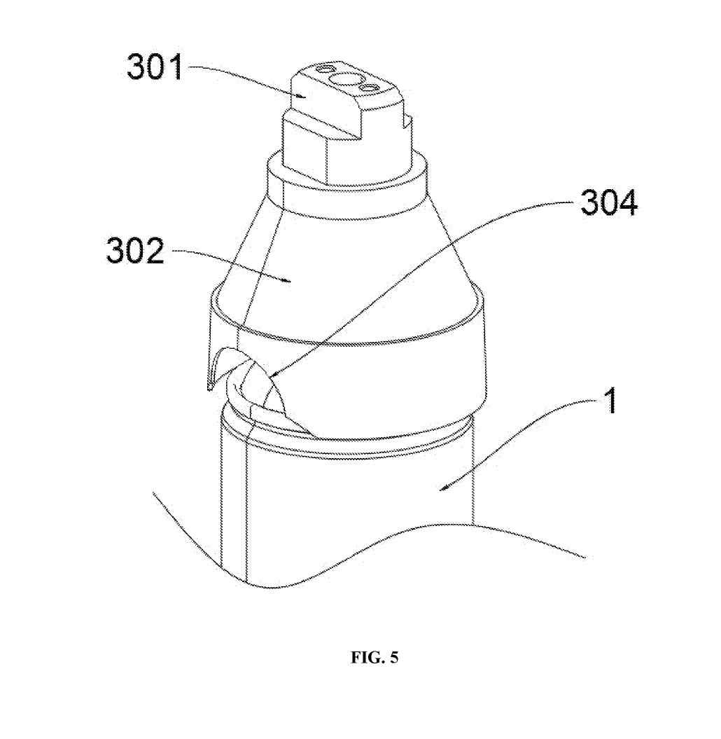

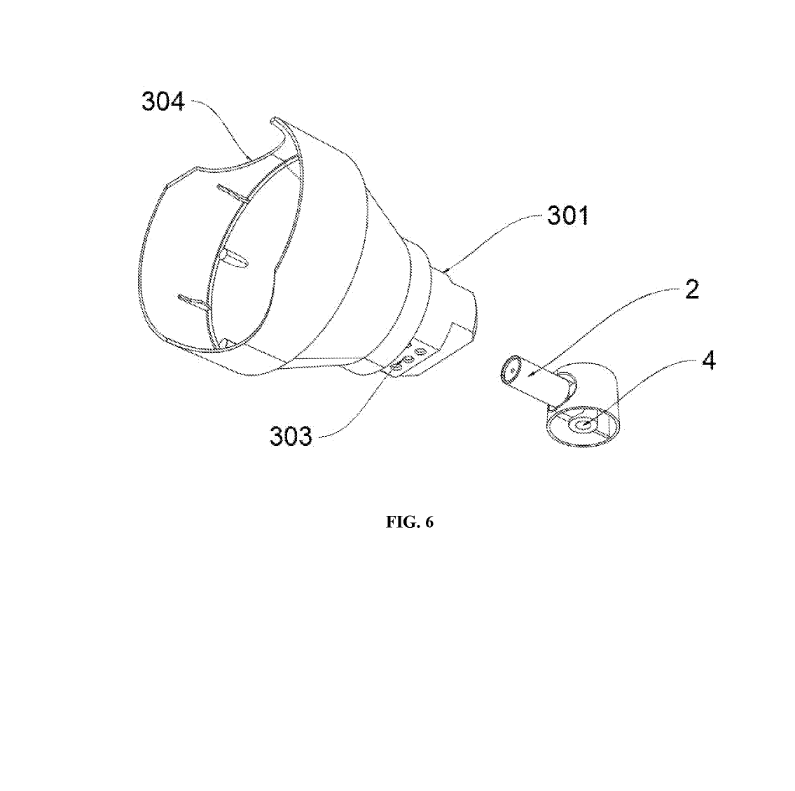

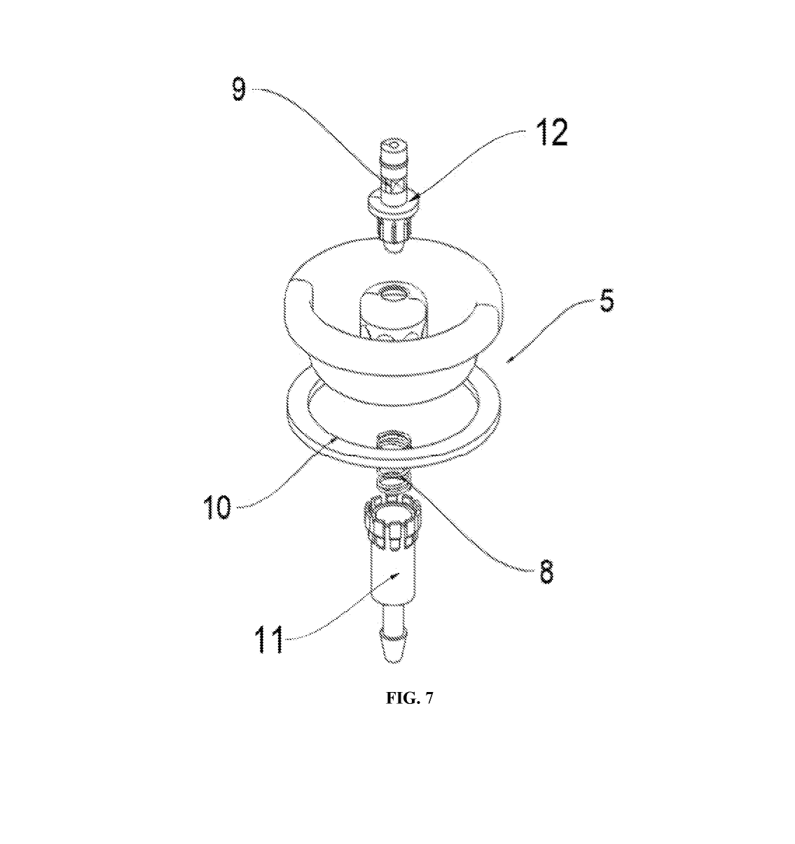

As shown in FIGS. 1-7, this embodiment provides a portable oxygen cylinder, including an oxygen cylinder body 1, an upper surface of the oxygen cylinder body 1 is provided with a through hole, a valve 5 is fixedly mounted on the through hole, a valve stem 9 is mounted on and connected to a surface of the valve 5, a pressing head 2 is slidably snap-fitted with a top end of the valve stem 9, a first sealing ring 10 is arranged on an inner side wall of the valve 5, the first sealing ring 10 is tightly against an inner wall of the valve 5, an oxygen mask 3 is slidably snap-fitted with one side of the pressing head 2, a flow groove 4 is formed inside the pressing head 2, a bottom end of the flow groove 4 is slidably snap-fitted with the valve stem 9, the pressing head 2 is adaptable to other types of oxygen masks, a recessed portion is formed on a surface of the pressing head 2, an anti-slide groove 6 is formed on a surface of the recessed portion, a rebound device 8 is arranged inside the valve 5, the valve stem 9 is mounted on one end of the rebound device 8, and a valve chamber 11 is mounted on the other end of the rebound device 8.

In this embodiment: when in use, a connecting portion 301 of the oxygen mask 3 is engaged with the pressing head 2, a user aligns the oxygen mask 3 with his/her nose and mouth, and adjusts the oxygen mask 3 to better fit his/her face; the pressing head 2 is then manually slid to open the valve, allowing oxygen to be discharged from an inside of the oxygen cylinder body 1 and outputted into the pressing head 2 after flowing through the valve 5, the oxygen inside the pressing head 2 is then transported out from one end of the pressing head 2 through the flow groove 4 inside the pressing head 2, and the pressing head 2 is inputted to a mask portion 302 via the connecting portion 301. After the user inhales the oxygen, an oxygen flow from the pressing head 2 is ceased when the pressing head 2 is released, exhaled gas is discharged through a ventilation hole 303, and the user can continue to make a next adjustment, and repeat an oxygen inhalation action.

The first sealing ring 10 is used to ensure the sealing between the valve 5 and the through hole during installation, preventing oxygen leakage and ensuring the practical performance of the portable oxygen cylinder;

The pressing head 2 is set as a standardized interface and is adaptable to other types of oxygen masks, improving the compatibility and flexibility of an oxygen mask system, thereby ensuring that the mask is compatible with various types of oxygen supply equipment, simplifying a use process, and broadening the applicability of the portable oxygen cylinder;

the rebound device 8 is used to allow the user to slide and use for many times, and the rebound device can prevent the oxygen leakage after rebounding, ensuring the sealing of the portable oxygen cylinder; and

the valve 5 includes an outermost valve sealing cup, the valve stem 9 slidably passes through an interior of the valve sealing cup, an outer surface of the valve stem 9 is provided with a second sealing ring 12 for a sealing connection between the valve stem 9 and the valve sealing cup, the first sealing ring 10 is arranged on an inner surface of the valve sealing cup, the first sealing ring 10 is used for a sealing between the valve sealing cup and the oxygen cylinder body 1, the valve chamber 11 is connected to a bottom of the valve sealing cup, the rebound device 8 is arranged inside the valve chamber 11, a top of the rebound device 8 is connected with the valve stem 9, and the rebound device 8 is used for rebound operation of the valve stem 9.

### Embodiment 2:

As shown in , FIGS. 1,2,3, and 6,and 6,the oxygen mask 3 includes a connecting portion 301 that is slidably snap-fitted with the pressing head 2, a connecting hole is formed on a surface of the connecting portion 301, the connecting hole is adapted to the pressing head 2, a mask portion 302 is fixedly mounted on one side of the connecting portion 301, a ventilation hole 303 is formed on a surface of the mask portion 302, one side of the mask portion 302 is set as an opening, upper and lower surfaces of the opening are both provided with arc-shaped grooves 304, and the arc-shaped grooves 304 are fitted to the user’s face.

In this embodiment: when wearing the oxygen mask 3, the mask portion 302 is fitted to the user’s face, the ventilation hole 303 is used to discharge the exhaled gas of the user, and the arc-shaped grooves 304 help the oxygen mask 3 better fit to the user’s face.

### Embodiment 3:

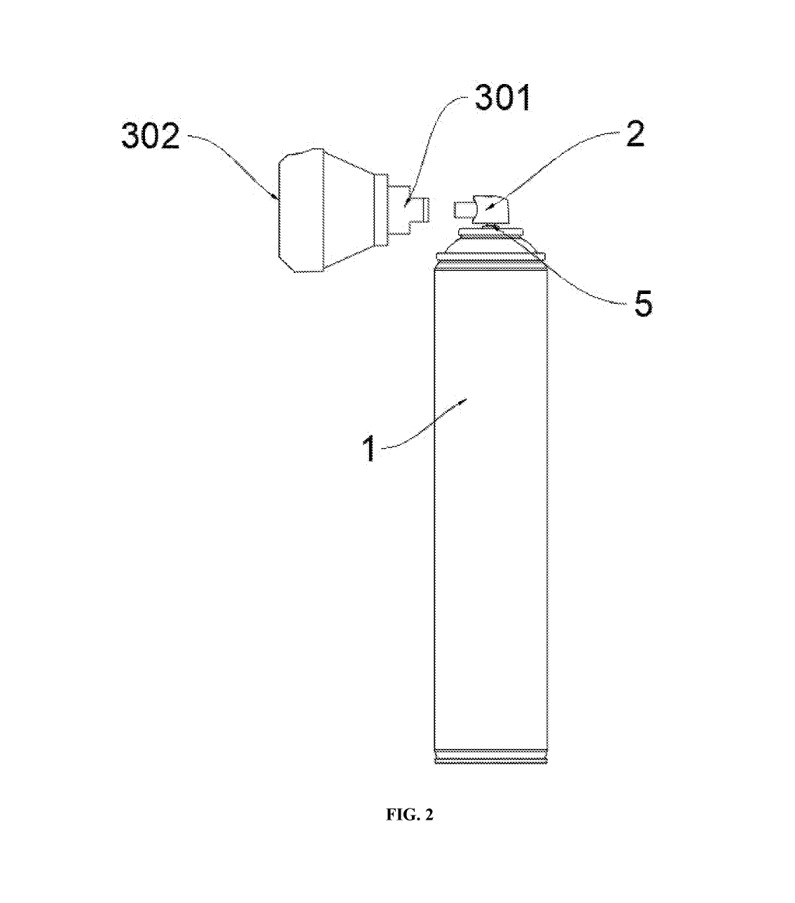

As shown in FIGS. 2, 4, and 5, a snap-fitted steel ring 7 is fixedly arranged on an upper surface of the oxygen cylinder body 1, a snap-fitted block is formed on an inner side wall of the mask portion 302, and the snap-fitted block is adapted to the snap-fitted steel ring 7.

In this embodiment: when the portable oxygen cylinder is not in use, the snap-fitted block on the inner wall of the mask portion 302 is engaged with the snap-fitted steel ring 7 on the surface of the oxygen cylinder body 1, such that the oxygen mask 3 is snap-fitted with the surface of the oxygen cylinder body 1, which is convenient for the user to carry. Further, the surface of the pressing head 2 is covered by the oxygen mask 3, reducing the risk of dust accumulation on the pressing head 2.

The above-mentioned terms “front”, “back”, “left”, “right”, “top” and “bottom” are all defined relative to FIG. 1 of the accompanying drawings in the Specification. According to an observation angle of the person, the side of the device facing the observer is defined as the front, the left side of the observer is defined as the left, and so on.

In the description of the present disclosure, it is to be understood that the terms "central", “longitudinal”, "transverse", “front”, “back”, “left”, “right”, “vertical”, “horizontal”, "top", "bottom", "inner", "outer", etc. indicate azimuthal or positional relations on the basis of those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure.

The above shows and describes the basic principles, main features and advantages of the present disclosure. It should be understood by those skilled in the art that, the present disclosure is not limited by the embodiments described above. The embodiments described above and the descriptions in the description merely illustrate the principles of the present disclosure. Various changes and modifications may be made to the present disclosure without departing from the spirit and scope of the present disclosure. These changes and modifications all fall within the claimed scope of the present disclosure. The claimed scope of the present disclosure is defined by the appended claims and their equivalents.

1. A portable oxygen cylinder, comprising an oxygen cylinder body, an upper surface of the oxygen cylinder body is provided with a through hole, a valve is fixedly mounted on the through hole, a valve stem is mounted on and connected to a surface of the valve, a pressing head is slidably snap-fitted with a top end of the valve stem, a first sealing ring is arranged on an inner side wall of the valve, the first sealing ring is tightly against an inner wall of the valve, an oxygen mask is slidably snap-fitted with one side of the pressing head, an outer surface of the valve stem is provided with a second sealing ring, and the second sealing ring is mounted on and connected to an interior of the valve.

2. The portable oxygen cylinder according to claim 1, wherein a flow groove is formed inside the pressing head, a bottom end of the flow groove is slidably snap-fitted with the valve stem, and the pressing head is adaptable to other types of oxygen masks.

3. The portable oxygen cylinder according to claim 2, wherein a recessed portion is formed on a surface of the pressing head, and an anti-slide groove is formed on a surface of the recessed portion.

4. The portable oxygen cylinder according to claim 1, wherein the oxygen mask comprises a connecting portion that is slidably snap-fitted with the pressing head, a connecting hole is formed on a surface of the connecting portion, the connecting hole is adapted to the pressing head, a mask portion is fixedly mounted on one side of the connecting portion, and a ventilation hole is formed on a surface of the mask portion.

5. The portable oxygen cylinder according to claim 4, wherein one side of the mask portion is set as an opening, upper and lower surfaces of the opening are both provided with arc-shaped grooves, and the arc-shaped grooves are fitted to a user’s face.

6. The portable oxygen cylinder according to claim 5, wherein a snap-fitted steel ring is fixedly arranged on an upper surface of the oxygen cylinder body, a snap-fitted block is formed on an inner side wall of the mask portion, and the snap-fitted block is adapted to the snap-fitted steel ring.

7. The portable oxygen cylinder according to claim 1, wherein a rebound device is arranged inside the valve, the valve stem is mounted on one end of the rebound device, and a valve chamber is mounted on the other end of the rebound device.
